(19) United States
(12) Patent Application Publication
(10) Pub. No.: US 2008/0195408 A1
(43) Pub. Date: Aug. 14, 2008

(54) Wireless Transactions

(76) Inventor: Adrian Michael Tatham, Kambah (AU)

Correspondence Address: RYDER IP LAW, PC, 107 NORTH BROAD STREET, SUITE 109, DOYLESTOWN, PA, 18901, US

(21) Appl. No.: 12/049,429

(22) Filed: Mar. 17, 2008

Related U.S. Application Data
(63) Continuation of application No. 10/398,724, filed on Oct. 7, 2003, now abandoned.

(30) Foreign Application Priority Data
Oct. 9, 2000 (AU) PR 0663

(51) Int. Cl. G06Q 30/00

(52) U.S. Cl. 705/1

(57) ABSTRACT

Methods and apparatus are disclosed for allowing an offering party to use a computer to send messages to individual wireless device users regarding a potential business transaction. Web based advise from the offering party is forwarded through a communications gateway. Replies from wireless device users are provided by links embedded in the messages. The links allow the wireless device users to reply to invitations to gather more information about the potential business transaction or to consummate the business transaction without needing to establish a new communication event with the offering party.

### FIELD OF THE INVENTION

The present invention relates to a wireless application protocol based system for making trading decisions and executing transactions in real time.

The invention has particular application to broker mediated trading activities over a network which includes a wireless telephonic connection to a purchaser and, for ease of understanding, the invention shall be described in relation to such activities, although it is to be understood that the scope of the invention is not limited thereto.

### BACKGROUND ART

Electronic trading by brokers over computer networks is becoming increasingly common. However, there has yet to be developed an interface between the new field of wireless application protocol (WAP) and general packet radio service (GPRS).

### SUMMARY DISCLOSURE OF THE INVENTION

The present invention seeks to draw together features of the present electronic trading system used by brokers, the present and future generation of WAP servers and WAP devices, and the broker's knowledge and advice giving capabilities to clients. Throughout this specification and the accompanying claims the words broker, vendor and seller will be used very broadly and interchangeably to refer to a person, organisation or company that provides a buyer with access to goods or services.

The invention provides a client or buyer with the opportunity to trade or purchase on an informed basis in real time.

The present invention will allow a broker, say of stocks, to initiate contact directly with the WAP enabled mobile telephones of a range of selected clients and provide them with urgent market information and associated knowledge. The clients will then be able to act upon advice from the stock broker via their WAP enabled telephones.

In one embodiment, the invention provides:

a method of selling, comprising the steps of:

Transmitting a web page to a seller, the page allowing the seller to generate a request which identifies one or more addressees and also specifies a content;

an information management system receiving the request and sending a first message to each addressee in response thereto;

the message being forwarded to each addressee through a gateway to a telecommunications system;

the first message comprising an alert and invitation to log onto the information management system;

receiving, using the information management system, a user ID and password from an addressee in response to the alert and invitation authenticating the addressee on the basis of the ID and password provided, then if the addressee is authenticated, forwarding a second message which includes the content portion;

using the information management system to receive an order sent by the addressee in reply to the second message, via the gateway; then forwarding the order to the seller's computer for processing by the seller.

Preferably, a JAVA™ servlet will serve wireless mark-up language (WML) pages to the WAP client, and the WML pages will be dynamically constructed from database content to provide stock market advice, enable the placement of stock market orders, and provide portfolio information.

### BRIEF DESCRIPTION OF THE DRAWINGS

FIG. 1 is a flow chart showing preferred steps in the implementation of a method of practising the invention, and

FIG. 2 is a schematic representation of the connectivity profile of a preferred system of the present invention.

### MODES FOR CARRYING OUT THE INVENTION

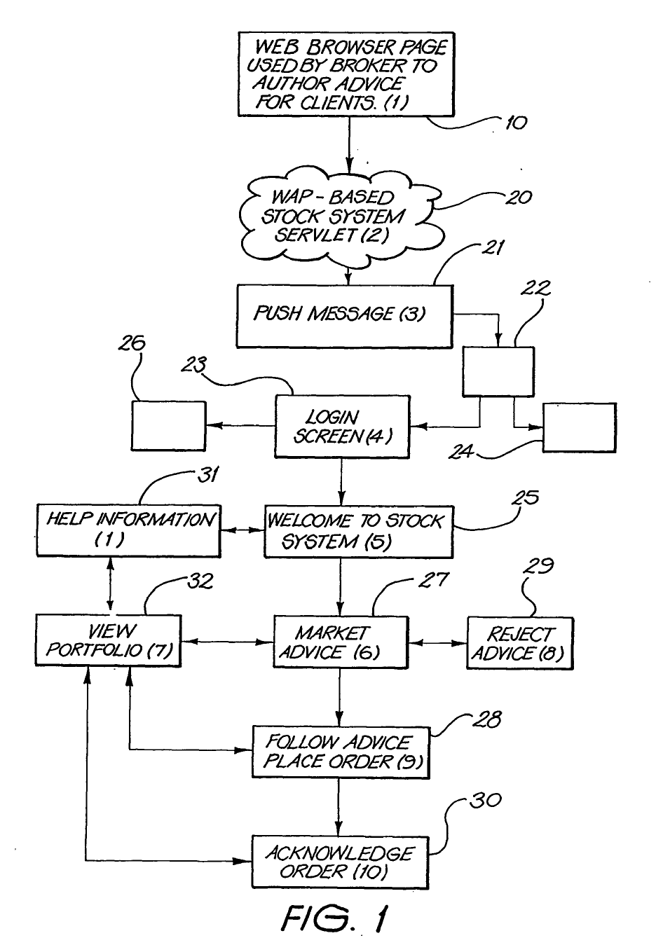

As shown in FIG. 1, the methods of the present invention relate to means for allowing a seller, vendor or broker of goods or services to send a message to remote clients, and receive direct response thereto, an order for those goods or services.

For the purposes of providing an example, the system of the present invention and its methods of performance will be specified with regard to a securities trader and their clients. It will be appreciated that the methods, software and apparatus herein disclosed will be equally suitable for a wide variety of different vendors, brokers and their clients. Throughout this specification and the accompanying claims the words broker, vendor and seller will be used very broadly and interchangeably to refer to a person, organisation or company that provides a buyer with access to goods or services.

An overview of the processors associated with the invention are depicted in FIG. 1. As shown there, a vendor or broker uses a conventional web browser 10 to author advice for selected clients (addressees). The web page is one provided by intermediary, as will be explained. The broker or vendor's advice may be unicast, multicast, or broadcast over the Internet by the intermediary and through a gateway into a telephonic or wireless communications system 20. The result is a message which is delivered to the client identified by the broker (push message) 21. The push or first message 21 is delivered over the telephone network to the individual clients. The message might read “you have urgent advice from XXX” or something similar. The client receives the message 22 on the appropriate recent telecommunications equipment as will be further explained. The messages akin to an alert sent by the broker to the client. If the client decides to abide by the alert, they are directed to a login screen 23 for entry of user ID and password. In the alternative, the user may choose to either ignore or postpone the invitation to login, thereby exiting the system 24, at least temporarily. The client suitably enabled telephone provides a login screen 23. Entry of the user ID and a password results in either entry into the ordering system 25 or refusal of entry 26. If the system determines that the user ID and password are acceptable, the user is provided with the broker's advice 27 initially provided through the broker's web browser.

In preferred embodiments, the broker's advice (content) 27 then appears on the user's communications device and may consist of particular advice, for example, the buying or selling of particular securities. If the user chooses to follow the content or advice they are guided through one or more screens which enable them to directly place an order 28. In the alternative, the user can reject the advice and exit the system 29. If an order is placed 28 the system responds with an acknowledgment 30 to let the user know that the order has been accepted and processed. It should be noted that at any time the user is logged into the system, help information 31 is available through the display device that was used to login 23. Similarly, port folio status and information 32 may also be displayed at the user's request.

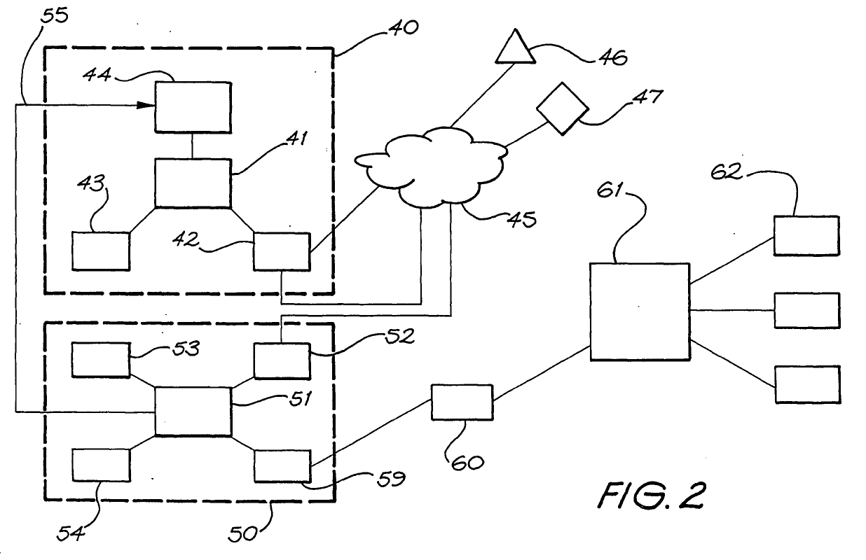

The system and methods of the present invention are explained in greater detail with reference to FIG. 2. As shown there, a trader's information management system 40 may comprise either a PC or server 41 which incorporates a web module 42 and an optional security module 43. Where the broker's information management system 40 is used to record and store client account or client contact details these may be stored, for example, in the broker's backend system 44. The broker's web module 42 is connected to, for example, the Internet 45, and is thereby adapted to receive information from any number of public or proprietary sources 46, 47. One of these sources may be a Stock Exchange.

As further shown in FIG. 2, the computer system 50 which interfaces with the broker's system 40 comprises a central PC or server 51 having a web module 52 and a security module 53. The web module 52 communicates with the broker's web module 42 via the Internet 45. If required, the information management system 50 may incorporate an optional storage module 54 which is adapted to record, store and maintain client and client account information required by the broker. The storage module 54 is capable of providing all the broker's information needs with respect to his clients but is not capable of actually performing a securities trading function.

As previously mentioned, the broker's web module 42 presents the broker with a web page through which the broker may access a list of clients, whether this list is provided by the storage module 54 or by the broker's backend 44. The broker uses this list to generate a request for a unicast, multicast or broadcast of messages to individual clients. Whether stored remotely or locally, the list is protected by security features which prevent tampering or abuse. The web page presented to the broker is preformatted to suit his individual needs. A broker or trader completes the empty fields in the web page form and sends the unicast, multicast or broadcast request through the Internet 45 to the web module 52. The information management system 51 converts the broker's HTML request to, for example, WML (WAP markup language) or XML language for transfer to the individual addressees. The WML or XML message is transferred to a suitable telecommunications gateway 60. Preferably, a JAVA™ servlet will serve wireless mark-up language (WML) pages to the WAP client, and the WML pages will be dynamically constructed from database content to provide stock market advice, enable the placement of stock market orders, and provide portfolio information.

It will be understood that the gateway could be, for example, an SMS gateway, a CSIM gateway or a GPRS gateway. CSIM refers to a particularised use of the WAP protocol which enables the transmission of live links to a WAP device and consequently the transmission from the remote WAP device of a request associated with the link. CSIM involves a Service Indicator (SI) designed to send a text message that contains an embedded link. This uses a function built into the Push specification from the WAP June 2000 specification. The SI is generated from an XML form using an SI template. The SI is written using XML DTD rules and is parsed into binary format for broadcast by the gateway. Thus, the message originally sent by the broker is then transmitted from the telecommunications gateway 62 as suitable telecommunications network 61 such as a GPRS, WAP or SMS network. From the network 61, the message is then transmitted to any number of individual users 62.

For wireless telephone user, they will receive the broker's alert message accompanied by an actual or facit invitation to buy or trade etc. The alert notifies them that they have advice from their broker, vendor or other trusted party. If the message arrives to the client 62 in an SMS format, they will have to escape from the SMS message and activate an Internet connection through a WAP service manually. In the alternative, and as previously mentioned, they may postpone or cancel the message.

If the alert is received through CSIM over WAP, the individual client 62 may activate a WAP session by activating a “hot” key on their mobile device or by postponing receiving their individualised message through a different “hot” key.

If the client is alerted by GPRS, they may either read the message or ignore it so long as the GPRS Internet connection is in “idle” mode.

As previously mentioned, the client may either accept the alert and proceed to receive the broker's message or advice or may decline it. If the alert is accepted and the provision of the user name and ID results in a successful login, a second message is transmitted in response to the broker's input. The second message comprises specific advice about particular products (content) and a positive response by the client 62 will result in a new screen being displayed on their communications device which allows them to enter an order a particular number of products or a particular monetary value.

Orders sent by our client through their remote device re-enters the telecommunications network and passes through the gateway 60 back through to the WAP, SMS or GPRS module 59 associated with the information management system 50. The information management system 50 then utilises the client's ID and password to verify the client. Verification information 55 may be provided directly to the broker through the web page etc. In the alternative, the ID and password information 55 may be provided to the broker's backend 44 so that the authentication process can be managed by the broker's system 40. It will be understood that if verification is not successful, the client 62 may be prompted to resubmit their ID and password or their order, for example, should the client exceed their authorised trading limit.

In preferred embodiments of the invention, the messages which are sent and received as between broker or vendor and client are date and time stamped and are stored in a secure fashion such that they cannot be altered, edited or amended. This provides an auditable record of the transactions between the broker or vendor and the client.

In other embodiments of the invention, a broker or vendor may forward more complete messages in the form of, for example, charts or graphs or text messages to be forwarded to a client's e-mail address or post office box if required.

It will be appreciated that the system of the present invention operates independent of any particular carrier or brand of telecommunications device. The methods and practices of the present invention are also independent of any particular protocol (eg GSM, CDMA, TDMA or GPRS).

In preferred embodiments of the invention, each screen presented to a client with regard to a client's placement of an order is accompanied by a link or option for the client to cancel the transaction. Further, to prevent the client from relying on stale information, the broker or vendor is able to elect a time window which accompanies their advice. The broker may use their web browser to specify an integral of time, eg, one hour within which a client's order for product or services may be accepted. Outside of that window, the order will be rejected by the information management system 50. In preferred embodiments, all orders for products or services must be proved or authorised by the vendor or broker on an individual basis and are not passed through to any automated trading systems without human appraisal of the situation.

In preferred embodiments, messages which are sent and received, even when they are stored in the information management system storage module 54 are not able to be reviewed or read by the operators of the information management system 50. The owners or operators of the information management system 50 may be able to review, for statistical or billing purposes, the number of messages sent and percentage of responses received but are actually able to review the contents of individual messages. In preferred embodiments, the broker or vendor is billed according to the number of orders placed through the system.

While the invention has been disclosed with reference to particular details and methods of operation, these should be understood as having been provided by way of example and not as limitations to the scope or spirit of the invention.

1. A computer system for performing remote business transactions with users of mobile internet enabled wireless devices, the computer system comprising:
an information management system used to generate an alert message for at least one addressee, wherein the alert message:
is related to a potential business transaction; and
is adapted to be displayed on a wireless device, and
includes an invitation to log on to the information management system to get additional content regarding the potential business transaction;
a storage medium for storing:
identification and contact information pertaining to at least one addressee and their at least one wireless device; and
the additional content regarding the potential business transaction;
web module, connected to a communications network, for receiving and sending HTML information to and from the information management system;
a WAP/SMS/GPRS module to:
transmit, via a telecommunications gateway, and a telecommunications network, the alert message, to the at least one wireless device associated with the at least one addressee;
receive, via the telecommunications gateway, a WML request to log into the information management system from the at least one wireless device of at least one addressee; and
communicate the WML information received from the at least one wireless device of the at least one addressee to the information management system for authenticating their identity, and if authenticated;
transmit the additional content regarding the potential business transaction, to the wireless device of the interested addressee via the telecommunications gateway in the form of WML information;
receive, via the communications network, instructions from the wireless device of the interested addressee via the telecommunications gateway in the form of WML information, which is directed to the information management system which then parses the information for instructions regarding the potential business transaction and then processes the transaction.

2. The system of claim 1, wherein the request to log into the information management system includes, at least, a user ID and password, and the authenticating includes authenticating the user ID and password.

3. The system of claim 2, wherein the alert message is generated by the information management system based on information related to the potential business transaction received by the information management system through the web module, over the communications network.

4. The system of claim 3 wherein the web module receives a request via the communications network from a party containing the information relating to a potential business transaction to be sent to at least one addressee.

5. The system of claim 4, where the communications network is the Internet.

6. The system of claim 5 wherein the request containing the information relating to a potential business transaction is provided by a user of a computer connected to the web module via the Internet.

7. The system of claim 6 where the web module of the information management system serves web pages that cause the computer connected via the Internet to display a form through which information is entered by the user and thereby transmitted to the information management system via the web module.

8. The system of claim 7 wherein the request further comprises the username and ID of the at least one addressee which is used by the information management system to compare against the requests to log in to the information management system received by the WAP/SMS/GPRS module so that the information management system can authenticate the identity of the at least one addressee, and wherein username and ID are stored in the storage module until such time that the request to log in to the information management system is received.

9. The system of claim 5 wherein the information management system authenticates the at least one addressee by sending the information contained in the request to log into the information management system received by the WAP/SMS/GPRS module to the party who sent the request containing the information relating to a potential business transaction, and wherein the party checks the username and ID against their own records and in turn provides the information management system, via the web module, with the authority to provide the additional content relating to a potential business transaction.

10. The system of claim 4, wherein the information received includes information from at least one proprietary source.

11. The system of claim 8 wherein the processing of the instructions provided by the at least one addressee comprises the information management system causing a transaction to occur through instructions provided via the web module to an information management system that conducts transactions.

12. The system of claim 9 wherein the processing of the instructions provided by the at least one addressee comprises the information management system providing instructions to the party who sent the request containing the information relating to a potential business transaction, via the web module, and where the instructions contain an authority from the addressee to proceed with the transaction, and wherein the party completes the transaction.
